(19) United States
(12) Patent Application Publication
(10) Pub. No.: US 2026/0108840 A1
(43) Pub. Date: Apr. 23, 2026

(54) PROCESS FOR OPTIMUM HYDROGEN RECOVERY DOWNSTREAM OF A SOLVENT-BASED CO2 REMOVAL UNIT

(71) Applicant: UOP LLC, Del Plaines, IL (US)

(72) Inventor: Bradley Russell, Longmont, CO (US)

(21) Appl. No.: 19/254,408

(22) Filed: Jun. 30, 2025

Related U.S. Application Data
(60) Provisional application No. 63/710,736, filed on Oct. 23, 2024.

(51) Int. Cl. B01D 53/047; B01D 53/14; B01D 53/22; C01B 3/36; C01B 3/50; C01B 3/52; C01B 3/56

(52) U.S. Cl. CPC B01D 53/047; B01D 53/1418; B01D 53/1475; B01D 53/1493; B01D 53/229; C01B 3/36; C01B 3/501; C01B 3/52; C01B 3/56; B01D 2252/204; B01D 2256/16; B01D 2257/102; B01D 2257/11; B01D 2257/502; B01D 2257/504; B01D 2257/7025; B01D 2257/80; C01B 2203/0244; C01B 2203/0405; C01B 2203/0415; C01B 2203/042; C01B 2203/047; C01B 2203/0475; C01B 2203/0495; C01B 2203/0816; C01B 2203/1241

(57) ABSTRACT

Hydrogen production processes with solvent-based CO₂ removal units having decreased carbon emissions in the fuel gas and reduced buildup of inert gases are described. The processes incorporate a hydrogen pressure swing adsorption (PSA) unit and a second separation unit, which can be a membrane separation unit, or a PSA unit. The membrane separation unit can be combined with a second PSA unit.

### RELATED APPLICATIONS

This application claims priority to U.S. Provisional Patent Application Ser. No. 63/710,736, filed on Oct. 23, 2024, the entirety of which is incorporated herein by reference.

### BACKGROUND

Hydrogen is expected to have significant growth potential because it is a clean-burning fuel. However, hydrogen production is traditionally a significant emitter of CO₂, and government regulations and societal pressures are increasingly taxing or penalizing CO₂ emissions. Consequently, significant competition to lower the cost of hydrogen production while recovering the byproduct CO₂ for subsequent geological sequestration to capture the growing market is anticipated. CO₂ can be separated as a vapor to be supplied to a common pipeline, but more likely it will need to be produced in liquefied form for easy transport by truck or ship due to the current lack of CO₂ pipeline infrastructure in certain areas of the world.

In some applications, greater than 95% CO₂ capture from steam reforming or autothermal reforming or greater than 90% including CO₂ impact from utilities is desired, and may soon be required. However, even lower CO₂ capture percentages from hydrogen production plants, such as 50% to 60%, can be desirable from an economic perspective, especially when the CO₂ recovery system is retrofitted to an existing steam reforming plant. In such cases, CO₂ can be economically recovered from the shifted synthesis gas (pre-combustion capture). In addition to steam reforming hydrogen plants, synthesis gas CO₂ capture can also be desirable in other hydrocarbon or fossil fuel conversion processes, such as autothermal reforming (ATR), gasification, or partial oxidation (POX).

Most existing hydrogen production processes are based on steam reforming with natural gas or naphtha feedstock (SMR processes) and utilize pressure swing adsorption (PSA) to recover high-purity product hydrogen from shifted syngas. The low-pressure tail gas stream from the PSA unit is typically combusted in the SMR furnace along with supplemental natural gas fuel to generate heat for the process.

Autothermal reforming (ATR) for Blue Hydrogen production is typically the preferred technology option for large-scale greenfield projects. Blue Hydrogen is a common designation for hydrogen produced from hydrocarbon feedstocks (such as natural gas or naphtha) when carbon dioxide produced in the process is captured and geologically sequestered or utilized to avoid CO₂ emissions to the atmosphere.

In many cases, an amine solvent unit is chosen for CO₂ capture from shifted synthesis gas. There is increasing market interest in pressure-swing adsorption (PSA) for hydrogen purification downstream of the amine unit, even for ammonia projects as an alternative to nitrogen wash technology. Accordingly, there have been recent patent applications covering the use of a PSA unit downstream of the amine system. However, these prior art schemes have limitations with respect to carbon intensity (e.g., US Publication Nos. 2023/0174377 and 2023/0271829) and the build-up of inert gases in the ATR recycle loop (e.g., US Publication No. 2024/0124302) that can be problematic in certain situations. This depends on project-specific constraints related the following variables: (1) H₂ product purity, e.g., 98.0 mol % vs. 99.9 mol % vs. 99.97 mol %; (2) Fuel gas duty for the ATR process, e.g., 1200 to 6000 kJ/kg H₂ product (low fuel requirement) vs. 12,000 to 24,000 kJ/kg H₂ product (high fuel requirement); and (3) Inerts concentration in the synthesis gas, e.g., less than 200 ppmv argon and less than 2000 ppmv nitrogen (low inerts level) vs. greater than 600 ppmv argon and greater than 6000 ppmv nitrogen in syngas (high inerts level).

Therefore, there is a need for economical hydrogen production processes having decreased carbon emissions in fuel gas and reduced buildup of inert gases in the process.

### BRIEF DESCRIPTION OF THE DRAWINGS

FIG. 1 is an illustration of one embodiment of a hydrogen production process according to the present invention.

FIG. 2 is an illustration of another embodiment of a hydrogen production process according to the present invention.

FIG. 3 is an illustration of another embodiment of a hydrogen production process according to the present invention.

FIG. 4 is an illustration of one embodiment of a three-product pressure swing adsorption unit.

FIG. 5 is an illustration of prior art hydrogen production process for the comparison used in Example 1.

FIG. 6 is an illustration of prior art hydrogen production process for the comparison used in Example 2.

### DESCRIPTION

The present invention meets this need by providing a general process arrangement that can be customized for optimal performance in different process situations.

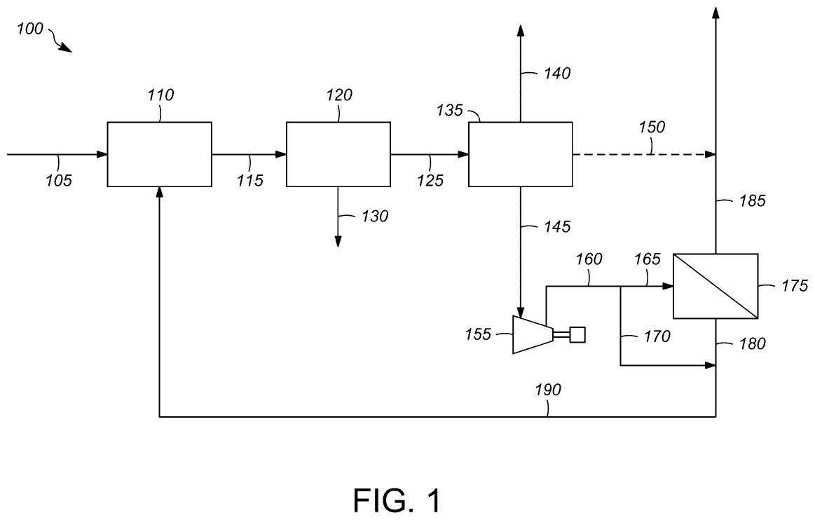

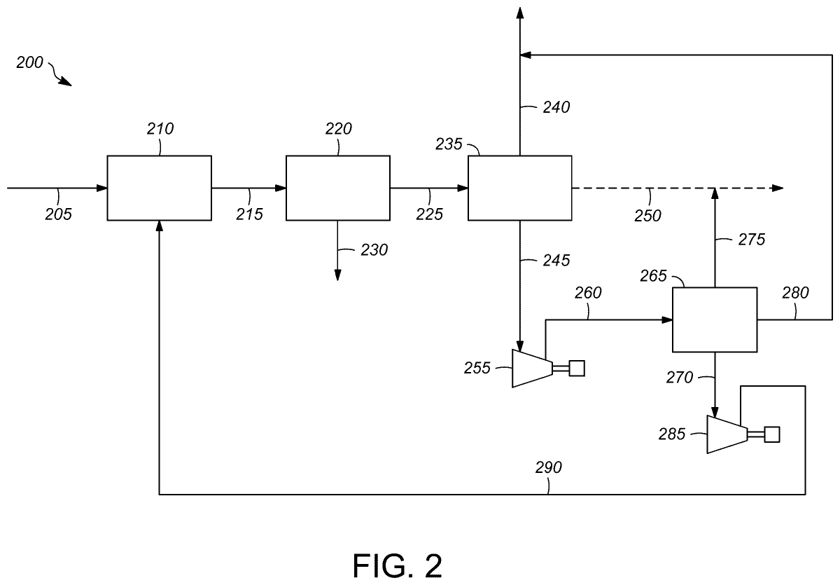

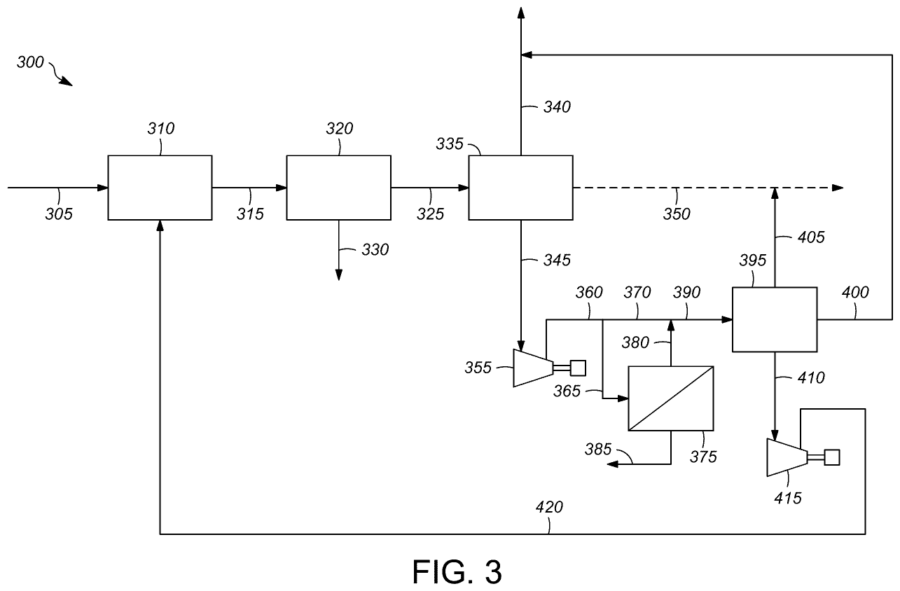

The H₂ product purity, fuel gas duty for the hydrogen production process, and inerts concentration in the synthesis gas determine which of the processes discussed below is appropriate. For example, the process of FIG. 1 can be advantageous when the fuel requirement is high (e.g., greater than 12,000 kJ/kg H₂ product), the inerts level in the syngas is low to moderate, and the hydrogen purity requirement is low to moderate (e.g., 98.0 mol % to 99.9 mol %). The process of FIG. 2 can be used when the hydrogen purity requirement is high (e.g., 99.97 mol %), the feed stream has a high level of inert gases (e.g., greater than about 600 ppmv argon and/or greater than about 6000 ppmv nitrogen), and the fuel requirement is low (e.g., less than 6000 kJ/kg H₂ product). The process of FIG. 3 can be used when the hydrogen purity is high (e.g., 99.97 mol % or 99.99 mol %), and the feed stream has a high level of inert gases (e.g., greater than about 600 ppmv argon and/or greater than about 6000 ppmv nitrogen). In this case, the fuel requirement can be high or low. It is understood that many combinations of hydrogen product purity, fired fuel duty, and inerts level in syngas are possible, and the process can be selected and optimized for any given set of project constraints. The processes of FIGS. 1, 2, and 3 are particularly advantageous because they minimize carbon emissions in the fuel gas and prevent excessive build-up of inerts (nitrogen and argon) in the hydrogen production process.

One aspect of the invention is a hydrogen production process. In one embodiment, the hydrogen production process comprises providing a feed stream comprising synthesis gas from a hydrogen production process unit, the feed stream comprising hydrogen, carbon dioxide, and at least one of carbon monoxide, methane, water, nitrogen, and argon. The feed stream is passed through a solvent-based CO₂ removal unit to form a CO₂-lean feed stream. The CO₂-lean feed stream is separated in a hydrogen pressure swing adsorption (PSA) unit to form a hydrogen product stream enriched in hydrogen, a hydrogen-depleted tail gas stream comprising hydrogen, and at least one of carbon monoxide, methane, water, the nitrogen, and the argon, and optionally a vent gas stream comprising hydrogen and at least one of the nitrogen and the argon. The hydrogen-depleted tail gas stream is compressed in a tail gas compressor forming a compressed tail gas stream. At least a first portion of the compressed tail gas stream is separated in a second separation unit into a first stream comprising the methane and the carbon monoxide, a second stream comprising a portion of the hydrogen and a portion of the nitrogen and the argon, and optionally a third stream comprising a portion of the hydrogen. The first stream is recycled to the hydrogen production process, and the second stream is passed to a burner.

In some embodiments, the solvent-based CO₂ removal unit comprises an amine-based CO₂ removal unit, a methanol-based CO₂ removal unit, a dimethyl ether of propylene glycol (DEPG)-based CO₂ removal unit, or combinations thereof.

In some embodiments, the second separation unit comprises a membrane separation unit, and further comprising: dividing the compressed tail gas stream into the first portion and a second portion; passing the second stream from the membrane separation unit to the burner; and recycling the first stream from the membrane separation unit and the second portion of the compressed tail gas stream to the hydrogen production process unit.

In some embodiments, the second separation unit comprises a second hydrogen PSA unit, and wherein the third stream is present, and wherein separating at least the first portion of the compressed tail gas stream in the second separation unit comprises separating the entire compressed tail gas stream in the second hydrogen PSA unit into the first stream, the second stream, and the third stream, further comprising; recycling the first stream from the second hydrogen PSA unit to the hydrogen production process unit; passing the second stream from the second hydrogen PSA unit to the burner; and recovering the third stream from the second hydrogen PSA unit as a second hydrogen product stream.

In some embodiments, the vent gas stream from the hydrogen PSA unit is present, further comprising: combining the vent gas stream from the hydrogen PSA unit and the second stream from the second hydrogen PSA unit to form a combined vent gas stream; and wherein passing the second stream to the burner comprises passing the combined vent gas stream to the burner.

In some embodiments, the hydrogen PSA unit, or the second hydrogen PSA unit, or both are three-product PSA units.

In some embodiments, the second hydrogen PSA unit is a three-product PSA unit, and wherein the second stream comprises a vent gas stream having a pressure between the pressure of the first stream and the third stream.

In some embodiments, the process further comprises compressing the first stream from the second hydrogen PSA unit before recycling the first stream to the hydrogen production process unit.

In some embodiments, the second separation unit comprises a membrane separation unit, and further comprising: dividing the compressed tail gas stream into the first portion and a second portion; separating the first portion of the compressed tail gas stream in the membrane separation unit into the first stream, and the second stream; separating the first stream from the membrane separation unit and the second portion of the compressed tail gas stream in a second hydrogen PSA unit into a second hydrogen product stream, a second vent gas stream comprising hydrogen, nitrogen, and argon, and a second tail gas stream comprising the carbon monoxide and the methane; passing the second stream from the membrane separation unit and the second vent gas stream from the second hydrogen PSA unit to the burner; compressing the second tail gas stream from the second hydrogen PSA unit to form a second compressed tail gas stream; recycling the second compressed tail gas stream to the hydrogen production process unit; and recovering the second hydrogen product stream.

In some embodiments, the vent gas stream from the hydrogen PSA unit is present and comprises a portion of the hydrogen, and a portion of at least one of the nitrogen, and the argon and wherein the vent gas stream is combined with the second stream to form a combined fuel gas stream and wherein the combined fuel gas stream is sent to a burner.

In some embodiments, the combined fuel gas stream comprises 1% to 20% of an amount of the hydrogen in the feed stream, or wherein the combined fuel gas stream comprises 10% to 60% of an amount of the nitrogen and the argon in the feed stream, or both.

In some embodiments, the vent gas stream from the hydrogen PSA unit is present, and further comprising: combining the vent gas stream from the hydrogen PSA unit, the second stream from the membrane separation unit, and the second vent gas stream from the second hydrogen PSA unit to form a combined fuel gas stream; and wherein passing the second stream from the membrane separation unit and the second vent gas stream from the second hydrogen PSA unit to the burner comprises passing the combined fuel gas stream to the burner.

In some embodiments, the combined fuel gas stream comprises 1% to 20% of an amount of the hydrogen in the feed stream, or wherein the combined fuel gas stream comprises 10% to 60% of an amount of the nitrogen and the argon in the feed stream, or both.

In some embodiments, the second stream from the second separation unit comprises an amount of the carbon monoxide, or the methane, or both less than an amount of the carbon monoxide, or the methane, or both in the feed stream.

In some embodiments, the hydrogen product stream comprises greater than 98 mol % hydrogen.

In some embodiments, the hydrogen production process unit comprises a steam methane reforming unit, an autothermal reforming unit, a gasification unit, a partial oxidation unit, or combinations thereof.

Another aspect of the invention is an apparatus for hydrogen production. In one embodiment, the apparatus comprises: a hydrogen production unit having an inlet and an outlet; a hydrogen PSA unit having an inlet, a hydrogen product outlet, a tail gas outlet, and optionally a vent gas outlet, the inlet of the hydrogen PSA unit being in downstream fluid communication with the outlet of the hydrogen production unit; a compressor having an inlet and an outlet, the inlet of the compressor being in downstream fluid communication with the tail gas outlet of the hydrogen PSA unit; a second separation unit having an inlet, a first outlet, and a second outlet, the inlet of the second separation unit being in downstream fluid communication with the outlet of the compressor, the inlet of the hydrogen production unit being in downstream fluid communication with the first outlet of the second separation unit; and a burner having an inlet in downstream fluid communication with the second outlet of the second separation unit and optionally the vent gas outlet of the hydrogen PSA unit.

In some embodiments, the second separation unit comprises a membrane separation unit, and wherein the inlet of the hydrogen production unit is in downstream fluid communication with the outlet of the compressor.

In some embodiments, the second separation unit comprises a second hydrogen PSA unit having a third outlet, further comprising: a second compressor having an inlet and an outlet, the inlet of the second compressor being in downstream fluid communication with the first outlet of the second PSA unit, and the inlet of the hydrogen production unit being in downstream fluid communication with the outlet of the second compressor.

In some embodiments, the second separation unit comprises a membrane separation unit, and further comprising; a second hydrogen PSA unit having an inlet, a second hydrogen product outlet, a second vent gas outlet, and a second tail gas outlet, the inlet of the second hydrogen PSA unit being in downstream fluid communication with the outlet of the compressor and the first outlet of the membrane separation unit, the burner being in downstream fluid communication with the second vent gas outlet of the second hydrogen PSA unit and the second outlet of the membrane separation unit; a second compressor having an inlet and an outlet, the inlet of the second compressor being in downstream fluid communication with the tail gas outlet of the second hydrogen PSA unit, the inlet of the hydrogen production unit being in downstream fluid communication with the outlet of the second compressor.

FIG. 1 illustrates one embodiment of the hydrogen production process 100. A hydrocarbon feed stream 105 comprising a hydrocarbon is sent to the hydrogen production process unit 110. The hydrocarbon feed stream may comprise any suitable hydrocarbon stream including, but not limited to, natural gas, naphtha, liquefied petroleum gas (LPG), and combinations thereof.

Any suitable hydrogen production process unit may be used, including, but not limited to, steam reforming, autothermal reforming (ATR), gasification, or partial oxidation (POX). The reforming and water-gas shift reactions produce a reformed feed stream 115 comprising hydrogen, carbon dioxide, and at least one of carbon monoxide, methane, water, nitrogen, and argon.

Reformed feed stream 115 is sent to a solvent-based CO₂ removal unit 120 where carbon dioxide is removed forming a CO₂-lean feed stream 125 and a CO₂-rich solvent stream 130. Any suitable solvent-based CO₂ removal unit can be used including, but not limited to, an amine-based CO₂ removal unit, a methanol-based CO₂ removal unit, a dimethyl ether of propylene glycol (DEPG)-based CO₂ removal unit, or combinations thereof.

The CO₂-lean feed stream 125 is sent to the hydrogen pressure swing adsorption (PSA) unit 135 where it is separated into a hydrogen product stream 140 enriched in hydrogen and a hydrogen depleted tail gas stream 145 comprising a portion of the hydrogen, and at least one of the carbon monoxide, the methane, the water, the nitrogen, and the argon. The hydrogen PSA unit 135 may optionally form a vent gas stream 150 comprising hydrogen and at least one of the nitrogen and the argon.

The hydrogen product stream 140 can be recovered, and the optional vent gas stream 150 can be sent to a burner (not shown).

The hydrogen depleted tail gas stream 145 is compressed in compressor 155 forming compressed tail gas stream 160. The compressed tail gas stream 160 is divided into a first portion 165 and a second portion 170.

The first portion 165 of the compressed tail gas stream 160 is sent to a membrane separation unit 175 where it is separated into a retentate (first) stream 180 comprising the methane and the carbon monoxide and a permeate (second) stream 185. The permeate stream 185 is sent to a burner (not shown). This can be the same burner as the one the optional vent gas stream 150 is sent to, or it could be a different one.

The retentate stream 180 from the membrane separation unit 175 may be combined with the second portion 170 of the compressed tail gas stream 160, and the combined stream 190 (or the individual streams) is recycled to the hydrogen production process unit 110.

FIG. 2 illustrates a second embodiment of the hydrogen production process 200. A hydrocarbon feed stream 205 comprising a hydrocarbon is sent to the hydrogen production process unit 210.

Reformed feed stream 215 is sent to a solvent-based CO₂ removal unit 220 where carbon dioxide is removed forming a CO₂-lean feed stream 225 and a CO₂-rich solvent stream 230.

The CO₂-lean feed stream 225 is sent to the first hydrogen PSA unit 235 where it is separated into a hydrogen product stream 240 and a hydrogen depleted tail gas stream 245. The first hydrogen PSA unit 235 may optionally form a vent gas stream 250.

The hydrogen product stream 240 can be recovered, and the optional vent gas stream 250 can be sent to a burner (not shown).

The hydrogen depleted tail gas stream 245 is compressed in compressor 255 forming compressed tail gas stream 260.

The compressed tail gas stream 260 is separated in a second hydrogen PSA unit 265 into a first stream 270 (a tail gas stream) comprising the methane and the carbon monoxide, a second stream 275 (a vent gas stream) comprising a portion of the hydrogen, the nitrogen, and the argon, and a third stream 280 (a hydrogen product stream) comprising a portion of the hydrogen.

The third stream 280 can be combined with the hydrogen product stream 240 from the first hydrogen PSA unit 235 and recovered (or the individual streams can be recovered). The second stream 275 can be combined with the vent gas stream 250 from the first hydrogen PSA unit 235 and sent to a burner (not shown). This can be the same burner as the one the optional vent gas stream 250 is sent to, or it could be a different one.

The first stream 270 is sent to a second compressor 285, and the compressed first stream 290 is recycled to the hydrogen production process unit 210.

FIG. 3 illustrates one embodiment of the hydrogen production process 300. A hydrocarbon feed stream 305 comprising a hydrocarbon is sent to the hydrogen production process unit 310.

Reformed feed stream 315 is sent to a solvent-based CO₂ removal unit 320 where carbon dioxide is removed forming a CO₂-lean feed stream 325 and a CO₂-rich solvent stream 330.

The CO₂-lean feed stream 325 is sent to the hydrogen PSA unit where it is separated into a hydrogen product stream 340 enriched in hydrogen and a hydrogen depleted tail gas stream 345 comprising a portion of the hydrogen, and at least one of the carbon monoxide, the methane, the water, the nitrogen, and the argon. The first hydrogen PSA unit 335 may optionally form a optional vent gas stream 350 comprising hydrogen and at least one of the nitrogen and the argon.

The hydrogen product stream 340 can be recovered, and the optional vent gas stream 350 can be sent to a burner (not shown).

The hydrogen depleted tail gas stream 345 is compressed in compressor 355 forming compressed tail gas stream 360. The compressed tail gas stream 360 is divided into a first portion 365 and a second portion 370.

The first portion 365 of the compressed tail gas stream 360 is sent to a membrane separation unit 375 where it is separated into a retentate (first) stream 380 comprising the methane and the carbon monoxide and a permeate (second) stream 385. The permeate stream 385 is sent to a burner (not shown). This can be the same burner as the one the optional vent gas stream 350 is sent to, or it could be a different one.

The retentate stream 380 from the membrane separation unit 375 is combined with the second portion 370 of the compressed tail gas stream 360. The combined stream 390 is sent to a second hydrogen PSA unit 395 where it is separated into a second hydrogen product stream 400, a second vent gas stream 405, and a second tail gas stream 410.

The second hydrogen product stream 400 can be combined with the hydrogen product stream 340 from the first hydrogen PSA unit 335 and recovered (or the individual streams can be recovered). The second vent gas stream 405 can be combined with the optional vent gas stream 350 from the first hydrogen PSA unit 335 and sent to a burner (not shown). This can be the same burner as the one the optional vent gas stream 350 is sent to, or it could be a different one.

The second tail gas stream 410 is sent to a second compressor 415, and the second compressed tail gas stream 420 is recycled to the hydrogen production process unit 310.

When the vent gas stream is present in either the hydrogen PSA unit, or the second separation unit, a three-product PSA unit may be used. A three-product PSA unit is described in U.S. Pat. No. 12,036,505, which is incorporated herein in its entirety.

Utilizing a three-product PSA system instead of a conventional two-product PSA unit avoids the build-up of inerts (nitrogen and argon) in the process and eliminates the need to take a physical bleed stream to purge inerts which would result in carbon emissions in the bleed stream.

The three-product PSA system produces a high-pressure hydrogen product stream enriched in hydrogen, a low pressure tail gas stream enriched in carbon monoxide and methane, and an intermediate pressure vent gas stream enriched in nitrogen and argon.

The three-product PSA unit comprises a PSA adsorption vessel. There are generally at least six vessels, and typically eight to fourteen or more vessels. The vessels comprise one or more adsorbent layers, generally one to five, and typically two to three. The percentage of the bed for an adsorption layer is typically between 10% and 100%. Different layers of adsorbent have different selectivity for the components in PSA feed stream, as is known to those skilled in the art. Layers can include activated alumina or activated carbon at the feed end of the bed and molecular sieve zeolites at the product end of the bed (e.g., 5A or sodium X zeolite). Those of skill in the art will appreciate that other zeolites could be used and will know how to select appropriate adsorbents.

There is a first opening at one end of the vessel, and a second opening at the opposite end. For convenience, the ends will be referred to as the top and the bottom of the vessel. The first opening at the bottom is selectively connected to a high-pressure feed gas inlet line, and a low-pressure tail gas outlet line. The second opening at the top of the vessel is selectively connected to a high-pressure product outlet line, an intermediate-pressure vent gas outlet line, and a low-pressure purge gas inlet line.

The feed gas enters at high pressure through the first opening at the bottom of the vessel, and a high pressure, co-current adsorption and product removal step takes place with the hydrogen product exiting the vessel at high pressure through the second opening at the top of the vessel. There is at least one co-current depressurization step, and then an intermediate pressure co-current depressurization and vent gas removal step. The nitrogen and argon are removed through the opening at the top at an intermediate pressure. There is a counter-current blowdown step and a counter-current purge step. The purge gas enters through the opening at the top of the vessel at low pressure. The carbon monoxide and methane can be removed at low pressure through the opening at the bottom of the vessel during either or both of the counter-current blowdown step and the counter-current purge step. There is at least one counter-current re-pressurization step following the counter-current purge and tail gas removal step.

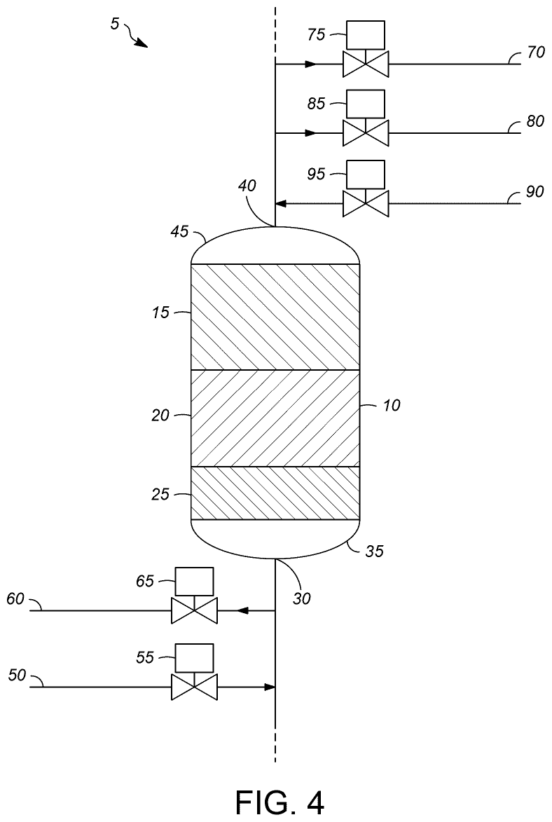

FIG. 4 illustrates a PSA unit 5 comprising a PSA adsorption vessel 10. The PSA adsorption vessel 10 includes three adsorption layers 15, 20, 25. The PSA adsorption vessel 10 includes a first opening 30 at a first end 35 and a second opening 40 at a second end 45. The first opening 30 is in selective fluid communication with high pressure feed gas inlet line 50 via valve 55 and with low pressure tail gas outlet line 60 via valve 65. The second opening 40 is in selective fluid communication with high pressure product outlet line 70 via valve 75, intermediate pressure vent gas outlet line 80 via valve 85, and low-pressure purge gas inlet line 90 via valve 95.

During the high pressure, co-current adsorption and product removal step of the PSA cycle, valves 55 and 75 are open and valves 65, 85, and 95 are closed, allowing the high-pressure feed gas to enter the PSA adsorption vessel 10 and the high-pressure product stream to exit.

During the at least one co-current depressurization step, valves 55, 65, 75, 85, and 95 are closed.

During the intermediate pressure co-current depressurization and vent removal step, valve 85 is open, and valves 55, 65, 75, and 95 are closed.

During the counter-current blowdown step and tail gas removal step, valve 65 is open, and valves 55, 75, 85, and 95 are closed. The bed de-pressurizes through valve 65, and some of the methane and carbon monoxide are desorbed.

During the counter-current purge and tail gas removal step, valves 65 and 95 are open, and valves 55, 75, and 85 are closed. The purge gas is introduced, and the carbon monoxide and methane are removed.

During the at least one counter-current re-pressurization step, valves 55, 65, 75, 85, and 95 are closed.

### Example 1

Computer simulations of a hydrogen production process were conducted based on autothermal reforming (ATR) with natural gas feedstock. An amine solvent unit was used to remove carbon dioxide from the shifted syngas. The resulting CO₂-lean gas from the amine unit is given below in Table 1. Carbon dioxide in the shifted syngas was about 25 mol %. The amine unit removed CO₂ to a level of 50 ppmv in the CO₂-lean gas. The absorbed CO₂ was recovered from the amine solvent and passed to a pipeline after compression and dehydration, ultimately for geological sequestration. In contrast to Example 2, the argon concentration in the CO₂-lean gas is much lower (100 ppmv vs. 900 ppmv) and the fired fuel requirement of the ATR process is much higher (950 GJ/hr vs. 147 GJ/hr). In addition, the hydrogen product purity requirement is lower (chemical-grade vs. mobility-grade).

TABLE 1
CO₂-lean gas from amine unit

| | |
|---|---|
| Pressure, bar(g) | 29 |
| Temperature, ° C. | 41 |
| Composition, mol % | |
| H₂ | 96.37 |
| CO₂ | 50 ppmv |
| Carbon Monoxide | 0.85 |
| Methane | 1.50 |
| Nitrogen | 1.00 |
| Argon | 100 ppmv |
| Water | 0.27 |
| Total | 100.00 |

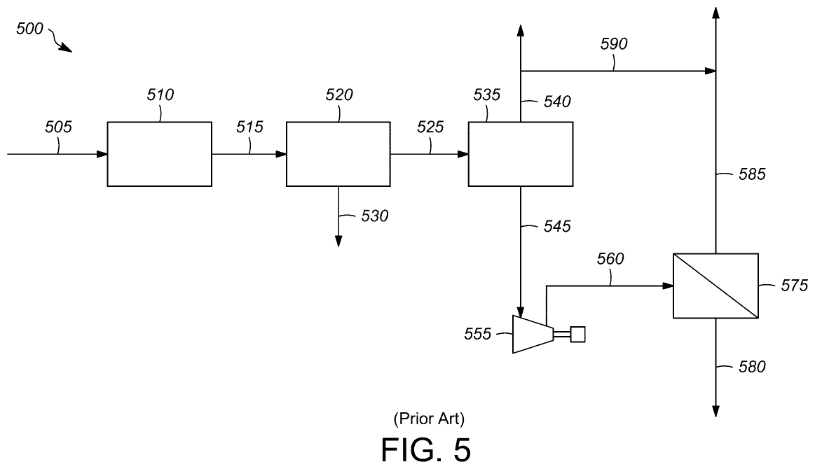

The CO₂-lean gas was routed to a hydrogen PSA unit for recovery of chemical-grade hydrogen product. A prior-art process shown in FIG. 5 was compared with the embodiment of the present invention shown in FIG. 1.

In the prior art process 500 of FIG. 5, a hydrocarbon feed stream 505 comprising a hydrocarbon is sent to the ATR hydrogen production process unit 510. The reforming and water-gas shift reactions produce a reformed feed stream 515 comprising hydrogen, carbon dioxide, and at least one of carbon monoxide, methane, water, nitrogen, and argon.

Reformed feed stream 515 is sent to an amine solvent CO₂ removal unit 520 where carbon dioxide is removed forming a CO₂-lean feed stream 525 and a CO₂-rich solvent stream 530.

The CO₂-lean feed stream 525 is sent to the hydrogen pressure swing adsorption (PSA) unit 535 where it is separated into a hydrogen product stream 540 enriched in hydrogen and a hydrogen depleted tail gas stream 545 comprising a portion of the hydrogen, and at least one of the carbon monoxide, the methane, the water, the nitrogen, and the argon.

The hydrogen product stream 540 is recovered.

The hydrogen depleted tail gas stream 545 is compressed in compressor 555 forming compressed tail gas stream 560.

The compressed tail gas stream 560 is sent to a membrane separation unit 575 where it is separated into a retentate (first) stream 580 comprising the methane and the carbon monoxide and a permeate (second) stream 585. The permeate stream 585 and a portion 590 of the hydrogen product stream 540 is sent to a burner (not shown).

The retentate stream 580 from the membrane separation unit 575 is recycled to the ATR hydrogen production process unit 510.

Key attributes of the present invention in FIG. 1 include the use of vent gas stream 150 from the hydrogen PSA unit 135 for producing low-carbon fuel gas and selectively rejecting inerts (nitrogen and argon) from the system, and the bypass of the second portion 170 of the compressed tail gas stream 160 around the membrane separation unit 175 for direct recycle to the upstream ATR hydrogen production process unit 110. This bypass of the membrane separation unit 175 allows the use of a high packing density membrane and a high stage-cut design, thus reducing membrane cost, as opposed to sending all of the compressed tail gas stream 160 to a low packing density membrane operating at low stage cut (higher membrane cost).

The results are given below in Table 2. An equal amount of chemical-grade hydrogen (22,350 kgmol/hr) and an equal amount of fired fuel (950 GJ/hr) were produced in both cases. Residual gas not recovered as hydrogen product or fuel was recycled to the upstream ATR process for further conversion of carbon monoxide and methane reactants. As indicated in Table 2, the present invention provides several benefits compared to the prior art process of FIG. 5. First, the carbon intensity of hydrogen production was significantly reduced; scope 1 (fired fuel) emissions were reduced from 2,930 kg CO₂/hr to 1,740 kg CO₂/hr. Second, the total gas compression power of the hydrogen recovery process was reduced from 24.1 MW to 17.2 MW. Third, the membrane size and cost were reduced (the total area decreased from 17,470 m² to just 5290 m²).

TABLE 2
Example 1

| | FIG. 1 (New Scheme) | FIG. 5 (Prior Art) |
|---|---|---|
| Hydrogen Product | | |
| Flow, kgmol/hr | 22,350 | 22,350 |
| Pressure, bar(g) | 28 | 28 |
| Temperature, ° C. | 45 | 45 |
| Composition, mol % | | |
| H₂ | 99.91 | 99.90 |
| CO₂ | — | — |
| Carbon Monoxide | 5 ppmv | 3 ppmv |
| Methane | — | — |
| Nitrogen | 810 ppmv | 904 ppmv |
| Argon | 79 ppmv | 85 ppmv |
| Water | — | — |
| Total | 100.00 | 100.00 |
| Fuel Gas Duty | | |
| Lower Heating Value, GJ/hr | 950 | 950 |
| Fired Fuel Emissions | | |
| kg CO₂/hr | 1740 | 2930 |
| Total Gas Compression Power | | |
| kW | 17,230 | 24,090 |
| ATR Recycle | | |
| kgmol/hr | | |
| Methane | 393 | 373 |
| Carbon Monoxide | 215 | 199 |
| Hydrogen | 1062 | 118 |
| Nitrogen | 612 | 2049 |
| Argon | 2.3 | 2.5 |
| Membrane Area | | |
| m² | 5290 | 17,470 |

### Example 2

Computer simulations of a hydrogen production process were conducted based on autothermal reforming (ATR) with natural gas feedstock. An amine solvent unit was used to remove carbon dioxide from the shifted syngas. The resulting CO₂-lean gas from the amine unit is given below in Table 3. Carbon dioxide in the shifted syngas was about 25 mol %. The amine unit removed CO₂ to a level of 50 ppmv in the CO₂-lean gas. The absorbed CO₂ was recovered from the amine solvent and passed to a pipeline after compression and dehydration, ultimately for geological sequestration.

TABLE 3
CO₂-lean gas from amine unit

| | |
|---|---|
| Pressure, bar(g) | 29 |
| Temperature, ° C. | 41 |
| Composition, mol % | |
| H₂ | 96.29 |
| CO₂ | 50 ppmv |
| Carbon Monoxide | 0.85 |
| Methane | 1.50 |
| Nitrogen | 1.00 |
| Argon | 900 ppmv |
| Water | 0.27 |
| Total | 100.00 |

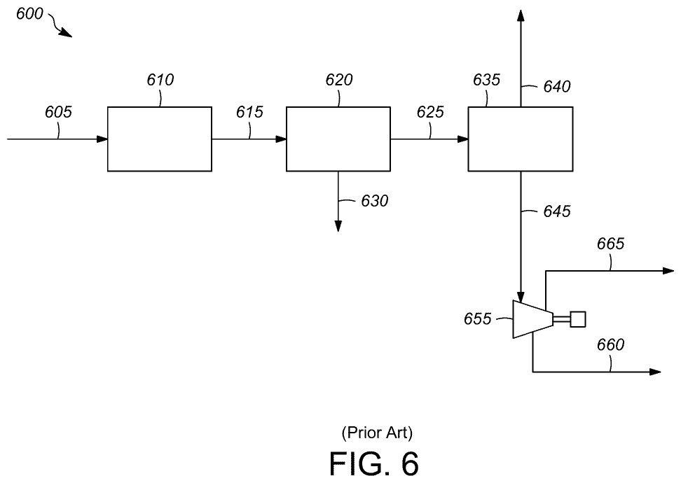

The CO₂-lean gas was routed to a hydrogen PSA unit for recovery of mobility-grade hydrogen product (ISO 14687 specification, Type 1, Grade D). A prior-art arrangement shown in FIG. 6 was compared with the embodiment of the present invention shown in FIG. 2.

In the prior art process 600 of FIG. 6 a hydrocarbon feed stream 605 comprising a hydrocarbon is sent to the ATR hydrogen production process unit 610.

Reformed feed stream 615 is sent to an amine solvent CO₂ removal unit 620 where carbon dioxide is removed forming a CO₂-lean feed stream 625 and a CO₂-rich solvent stream 630.

The CO₂-lean feed stream 625 is sent to the hydrogen PSA unit 635 where it is separated into a hydrogen product stream 640 and a hydrogen depleted tail gas stream 645. The hydrogen product stream 640 can be recovered.

The hydrogen depleted tail gas stream 645 is compressed in compressor 655 forming compressed tail gas stream 660 and compressed ATR recycle stream 665.

The compressed tail gas stream 660 is sent to a burner (not shown).

The compressed ATR recycle stream 665 is recycled to the ATR hydrogen production process unit 610.

The results are given below in Table 4. An equal amount of mobility-grade hydrogen (22,330 kgmol/hr) and an equal amount of fired fuel (147 GJ/hr) were produced in both cases. Residual gas not recovered as hydrogen product or fuel was recycled to the upstream ATR process for further conversion of carbon monoxide and methane reactants.

As indicated in Table 4, the present invention provides several benefits compared to the prior art process 600. First, the carbon intensity of hydrogen production is significantly reduced; scope 1 (fired fuel) emissions were reduced from 2,600 kg CO₂/hr to just 3.4 kg CO₂/hr. Second, the total gas compression power of the hydrogen recovery process was reduced from 27.6 MW to 24.2 MW. Third, the amount of undesirable ATR recycle was considerably reduced, thereby reducing the gas throughput and cost of the ATR section. For example, hydrogen recycle was reduced from 4115 kgmol/hr to 327 kgmol/hr, nitrogen recycle was reduced from 2264 kgmol/hr to 585 kgmol/hr, and argon recycle was reduced from 144 kgmol/hr to 20 kgmol/hr.

TABLE 4
Example 2

| | FIG. 2 (New Scheme) | FIG. 6 (Prior Art) |
|---|---|---|
| Hydrogen Product | | |
| Flow, kgmol/hr | 22,330 | 22,330 |
| Pressure, bar(g) | 28 | 28 |
| Temperature, ° C. | 45 | 45 |
| Composition, mol % | | |
| H₂ | 99.97 | 99.97 |
| CO₂ | — | — |
| Carbon Monoxide | — | — |
| Methane | — | — |
| Nitrogen | — | — |
| Argon | 291 ppmv | 298 ppmv |
| Water | — | — |
| Total | 100.00 | 100.00 |
| Fuel Gas Duty | | |
| Lower Heating Value, GJ/hr | 147 | 147 |
| Fired Fuel Emissions | | |
| kg CO₂/hr | 3.4 | 2600 |
| Total Gas Compression Power | | |
| kW | 24,210 | 27,620 |
| ATR Recycle | | |
| kgmol/hr | | |
| Methane | 359 | 340 |
| Carbon Monoxide | 203 | 192 |
| Hydrogen | 327 | 4115 |
| Nitrogen | 585 | 2264 |
| Argon | 19.7 | 144 |

### Specific Embodiments

While the following is described in conjunction with specific embodiments, it will be understood that this description is intended to illustrate and not limit the scope of the preceding description and the appended claims.

A first embodiment of the invention is a hydrogen production process comprising providing a feed stream comprising synthesis gas from a hydrogen production process unit, the feed stream comprising hydrogen, carbon dioxide, and at least one of carbon monoxide, methane, water, nitrogen, and argon; passing the feed stream through a solvent-based CO₂ removal unit to form a CO₂-lean feed stream; separating the CO₂-lean feed stream in a hydrogen pressure swing adsorption (PSA) unit to form a hydrogen product stream enriched in hydrogen, a hydrogen-depleted tail gas stream comprising hydrogen, and at least one of carbon monoxide, methane, water, the nitrogen, and the argon, and optionally a vent gas stream comprising hydrogen and at least one of the nitrogen and the argon; compressing the hydrogen-depleted tail gas stream in a tail gas compressor forming a compressed tail gas stream; separating at least a first portion of the compressed tail gas stream in a second separation unit into a first stream comprising the methane and the carbon monoxide, a second stream comprising a portion of the hydrogen and a portion of the nitrogen and the argon, and optionally a third stream comprising a portion of the hydrogen; recycling the first stream to the hydrogen production process; and passing the second stream to a burner. An embodiment of the invention is one, any or all of prior embodiments in this paragraph up through the first embodiment in this paragraph wherein the solvent-based CO₂ removal unit comprises an amine-based CO₂ removal unit, a methanol-based CO₂ removal unit, a dimethyl ether of propylene glycol (DEPG)-based CO₂ removal unit, or combinations thereof. An embodiment of the invention is one, any or all of prior embodiments in this paragraph up through the first embodiment in this paragraph wherein the second separation unit comprises a membrane separation unit, and further comprising dividing the compressed tail gas stream into the first portion and a second portion; passing the second stream from the membrane separation unit to the burner; and recycling the first stream from the membrane separation unit and the second portion of the compressed tail gas stream to the hydrogen production process unit. An embodiment of the invention is one, any or all of prior embodiments in this paragraph up through the first embodiment in this paragraph wherein the second separation unit comprises a second hydrogen PSA unit, and wherein the third stream is present, and wherein separating at least the first portion of the compressed tail gas stream in the second separation unit comprises separating the entire compressed tail gas stream in the second hydrogen PSA unit into the first stream, the second stream, and the third stream, further comprising; recycling the first stream from the second hydrogen PSA unit to the hydrogen production process unit; passing the second stream from the second hydrogen PSA unit to the burner; and recovering the third stream from the second hydrogen PSA unit as a second hydrogen product stream. An embodiment of the invention is one, any or all of prior embodiments in this paragraph up through the first embodiment in this paragraph wherein the vent gas stream from the hydrogen PSA unit is present, further comprising combining the vent gas stream from the hydrogen PSA unit and the second stream from the second hydrogen PSA unit to form a combined vent gas stream; and wherein passing the second stream to the burner comprises passing the combined vent gas stream to the burner. An embodiment of the invention is one, any or all of prior embodiments in this paragraph up through the first embodiment in this paragraph wherein the hydrogen PSA unit, or the second hydrogen PSA unit, or both are three-product PSA units. An embodiment of the invention is one, any or all of prior embodiments in this paragraph up through the first embodiment in this paragraph wherein the second hydrogen PSA unit is a three-product PSA unit, and wherein the second stream comprises a vent gas stream having a pressure between the pressure of the first stream and the third stream. An embodiment of the invention is one, any or all of prior embodiments in this paragraph up through the first embodiment in this paragraph further comprising compressing the first stream from the second hydrogen PSA unit before recycling the first stream to the hydrogen production process unit. An embodiment of the invention is one, any or all of prior embodiments in this paragraph up through the first embodiment in this paragraph wherein the second separation unit comprises a membrane separation unit further comprising dividing the compressed tail gas stream into the first portion and a second portion; separating the first portion of the compressed tail gas stream in the membrane separation unit into the first stream, and the second stream; separating the first stream from the membrane separation unit and the second portion of the compressed tail gas stream in a second hydrogen PSA unit into a second hydrogen product stream, a second vent gas stream comprising hydrogen, nitrogen, and argon, and a second tail gas stream comprising the carbon monoxide and the methane; passing the second stream from the membrane separation unit and the second vent gas stream from the second hydrogen PSA unit to the burner; compressing the second tail gas stream from the second hydrogen PSA unit to form a second compressed tail gas stream; recycling the second compressed tail gas stream to the hydrogen production process unit; and recovering the second hydrogen product stream. An embodiment of the invention is one, any or all of prior embodiments in this paragraph up through the first embodiment in this paragraph wherein the vent gas stream from the hydrogen PSA unit is present and comprises a portion of the hydrogen, and a portion of at least one of the nitrogen, and the argon and wherein the vent gas stream is combined with the second stream to form a combined fuel gas stream and wherein the combined fuel gas stream is sent to a burner. An embodiment of the invention is one, any or all of prior embodiments in this paragraph up through the first embodiment in this paragraph wherein the combined fuel gas stream comprises 1% to 20% of an amount of the hydrogen in the feed stream, or wherein the combined fuel gas stream comprises 10% to 60% of an amount of the nitrogen and the argon in the feed stream, or both. An embodiment of the invention is one, any or all of prior embodiments in this paragraph up through the first embodiment in this paragraph wherein the vent gas stream from the hydrogen PSA unit is present, further comprising combining the vent gas stream from the hydrogen PSA unit, the second stream from the membrane separation unit, and the second vent gas stream from the second hydrogen PSA unit to form a combined fuel gas stream; and wherein passing the second stream from the membrane separation unit and the second vent gas stream from the second hydrogen PSA unit to the burner comprises passing the combined fuel gas stream to the burner. An embodiment of the invention is one, any or all of prior embodiments in this paragraph up through the first embodiment in this paragraph wherein the combined fuel gas stream comprises 1% to 20% of an amount of the hydrogen in the feed stream, or wherein the combined fuel gas stream comprises 10% to 60% of an amount of the nitrogen and the argon in the feed stream, or both. An embodiment of the invention is one, any or all of prior embodiments in this paragraph up through the first embodiment in this paragraph wherein the second stream from the second separation unit comprises an amount of the carbon monoxide, or the methane, or both less than an amount of the carbon monoxide, or the methane, or both in the feed stream. An embodiment of the invention is one, any or all of prior embodiments in this paragraph up through the first embodiment in this paragraph wherein the hydrogen product stream comprises greater than 98 mol % hydrogen. An embodiment of the invention is one, any or all of prior embodiments in this paragraph up through the first embodiment in this paragraph wherein the hydrogen production process unit comprises a steam methane reforming unit, an autothermal reforming unit, a gasification unit, a partial oxidation unit, or combinations thereof.

A second embodiment of the invention is an apparatus for hydrogen production comprising a hydrogen production unit having an inlet and an outlet; a hydrogen PSA unit having an inlet, a hydrogen product outlet, a tail gas outlet, and optionally a vent gas outlet, the inlet of the hydrogen PSA unit being in downstream fluid communication with the outlet of the hydrogen production unit; a compressor having an inlet and an outlet, the inlet of the compressor being in downstream fluid communication with the tail gas outlet of the hydrogen PSA unit; a second separation unit having an inlet, a first outlet, and a second outlet, the inlet of the second separation unit being in downstream fluid communication with the outlet of the compressor, the inlet of the hydrogen production unit being in downstream fluid communication with the first outlet of the second separation unit; and a burner having an inlet in downstream fluid communication with the second outlet of the second separation unit and optionally the vent gas outlet of the hydrogen PSA unit. An embodiment of the invention is one, any or all of prior embodiments in this paragraph up through the second embodiment in this paragraph wherein the second separation unit comprises a membrane separation unit, and wherein the inlet of the hydrogen production unit is in downstream fluid communication with the outlet of the compressor. An embodiment of the invention is one, any or all of prior embodiments in this paragraph up through the second embodiment in this paragraph wherein the second separation unit comprises a second hydrogen PSA unit having a third outlet, further comprising a second compressor having an inlet and an outlet, the inlet of the second compressor being in downstream fluid communication with the first outlet of the second PSA unit, and the inlet of the hydrogen production unit being in downstream fluid communication with the outlet of the second compressor. An embodiment of the invention is one, any or all of prior embodiments in this paragraph up through the second embodiment in this paragraph wherein the second separation unit comprises a membrane separation unit, and further comprising; a second hydrogen PSA unit having an inlet, a second hydrogen product outlet, a second vent gas outlet, and a second tail gas outlet, the inlet of the second hydrogen PSA unit being in downstream fluid communication with the outlet of the compressor and the first outlet of the membrane separation unit, the burner being in downstream fluid communication with the second vent gas outlet of the second hydrogen PSA unit and the second outlet of the membrane separation unit; a second compressor having an inlet and an outlet, the inlet of the second compressor being in downstream fluid communication with the tail gas outlet of the second hydrogen PSA unit, the inlet of the hydrogen production unit being in downstream fluid communication with the outlet of the second compressor.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A hydrogen production process comprising:
providing a feed stream comprising synthesis gas from a hydrogen production process unit, the feed stream comprising hydrogen, carbon dioxide, and at least one of carbon monoxide, methane, water, nitrogen, and argon;
passing the feed stream through a solvent-based CO₂ removal unit to form a CO₂-lean feed stream;
separating the CO₂-lean feed stream in a hydrogen pressure swing adsorption (PSA) unit to form a hydrogen product stream enriched in hydrogen, a hydrogen-depleted tail gas stream comprising hydrogen, and at least one of carbon monoxide, methane, water, the nitrogen, and the argon, and optionally a vent gas stream comprising hydrogen and at least one of the nitrogen and the argon;
compressing the hydrogen-depleted tail gas stream in a tail gas compressor forming a compressed tail gas stream;
separating at least a first portion of the compressed tail gas stream in a second separation unit into a first stream comprising the methane and the carbon monoxide, a second stream comprising a portion of the hydrogen and a portion of the nitrogen and the argon, and optionally a third stream comprising a portion of the hydrogen;
recycling the first stream to the hydrogen production process; and
passing the second stream to a burner.

2. The process of claim 1 wherein the solvent-based CO₂ removal unit comprises an amine-based CO₂ removal unit, a methanol-based CO₂ removal unit, a dimethyl ether of propylene glycol (DEPG)-based CO₂ removal unit, or combinations thereof.

3. The process of claim 1 wherein the second separation unit comprises a membrane separation unit, and further comprising:
dividing the compressed tail gas stream into the first portion and a second portion;
passing the second stream from the membrane separation unit to the burner; and
recycling the first stream from the membrane separation unit and the second portion of the compressed tail gas stream to the hydrogen production process unit.

4. The process of claim 1 wherein the second separation unit comprises a second hydrogen PSA unit, and wherein the third stream is present, and wherein separating at least the first portion of the compressed tail gas stream in the second separation unit comprises separating the entire compressed tail gas stream in the second hydrogen PSA unit into the first stream, the second stream, and the third stream, further comprising;
recycling the first stream from the second hydrogen PSA unit to the hydrogen production process unit;
passing the second stream from the second hydrogen PSA unit to the burner;
and
recovering the third stream from the second hydrogen PSA unit as a second hydrogen product stream.

5. The process of claim 4 wherein the vent gas stream from the hydrogen PSA unit is present, further comprising:
combining the vent gas stream from the hydrogen PSA unit and the second stream from the second hydrogen PSA unit to form a combined vent gas stream;
and wherein passing the second stream to the burner comprises passing the combined vent gas stream to the burner.

6. The process of claim 4 wherein the hydrogen PSA unit, or the second hydrogen PSA unit, or both are three-product PSA units.

7. The process of claim 4 wherein the second hydrogen PSA unit is a three-product PSA unit, and wherein the second stream comprises a vent gas stream having a pressure between the pressure of the first stream and the third stream.

8. The process of claim 4 further comprising:
compressing the first stream from the second hydrogen PSA unit before recycling the first stream to the hydrogen production process unit.

9. The process of claim 1 wherein the second separation unit comprises a membrane separation unit further comprising:
dividing the compressed tail gas stream into the first portion and a second portion;
separating the first portion of the compressed tail gas stream in the membrane separation unit into the first stream, and the second stream;
separating the first stream from the membrane separation unit and the second portion of the compressed tail gas stream in a second hydrogen PSA unit into a second hydrogen product stream, a second vent gas stream comprising hydrogen, nitrogen, and argon, and a second tail gas stream comprising the carbon monoxide and the methane;
passing the second stream from the membrane separation unit and the second vent gas stream from the second hydrogen PSA unit to the burner;
compressing the second tail gas stream from the second hydrogen PSA unit to form a second compressed tail gas stream;
recycling the second compressed tail gas stream to the hydrogen production process unit; and
recovering the second hydrogen product stream.

10. The process of claim 1 wherein the vent gas stream from the hydrogen PSA unit is present and comprises a portion of the hydrogen, and a portion of at least one of the nitrogen, and the argon and wherein the vent gas stream is combined with the second stream to form a combined fuel gas stream and wherein the combined fuel gas stream is sent to a burner.

11. The process of claim 10 wherein the combined fuel gas stream comprises 1% to 20% of an amount of the hydrogen in the feed stream, or wherein the combined fuel gas stream comprises 10% to 60% of an amount of the nitrogen and the argon in the feed stream, or both.

12. The process of claim 9 wherein the vent gas stream from the hydrogen PSA unit is present, further comprising:
combining the vent gas stream from the hydrogen PSA unit, the second stream from the membrane separation unit, and the second vent gas stream from the second hydrogen PSA unit to form a combined fuel gas stream;
and wherein passing the second stream from the membrane separation unit and the second vent gas stream from the second hydrogen PSA unit to the burner comprises passing the combined fuel gas stream to the burner.

13. The process of claim 12 wherein the combined fuel gas stream comprises 1% to 20% of an amount of the hydrogen in the feed stream, or wherein the combined fuel gas stream comprises 10% to 60% of an amount of the nitrogen and the argon in the feed stream, or both.

14. The process of claim 1 wherein the second stream from the second separation unit comprises an amount of the carbon monoxide, or the methane, or both less than an amount of the carbon monoxide, or the methane, or both in the feed stream.

15. The process of claim 1 wherein the hydrogen product stream comprises greater than 98 mol % hydrogen.

16. The process of claim 1 wherein the hydrogen production process unit comprises a steam methane reforming unit, an autothermal reforming unit, a gasification unit, a partial oxidation unit, or combinations thereof.

17. An apparatus for hydrogen production comprising:
a hydrogen production unit having an inlet and an outlet;
a hydrogen PSA unit having an inlet, a hydrogen product outlet, a tail gas outlet, and optionally a vent gas outlet, the inlet of the hydrogen PSA unit being in downstream fluid communication with the outlet of the hydrogen production unit;
a compressor having an inlet and an outlet, the inlet of the compressor being in downstream fluid communication with the tail gas outlet of the hydrogen PSA unit;
a second separation unit having an inlet, a first outlet, and a second outlet, the inlet of the second separation unit being in downstream fluid communication with the outlet of the compressor, the inlet of the hydrogen production unit being in downstream fluid communication with the first outlet of the second separation unit; and
a burner having an inlet in downstream fluid communication with the second outlet of the second separation unit and optionally the vent gas outlet of the hydrogen PSA unit.

18. The apparatus of claim 17 wherein the second separation unit comprises a membrane separation unit, and wherein the inlet of the hydrogen production unit is in downstream fluid communication with the outlet of the compressor.

19. The apparatus of claim 17 wherein the second separation unit comprises a second hydrogen PSA unit having a third outlet, further comprising:
a second compressor having an inlet and an outlet, the inlet of the second compressor being in downstream fluid communication with the first outlet of the second PSA unit, and the inlet of the hydrogen production unit being in downstream fluid communication with the outlet of the second compressor.

20. The apparatus of claim 17 wherein the second separation unit comprises a membrane separation unit, and further comprising;
a second hydrogen PSA unit having an inlet, a second hydrogen product outlet, a second vent gas outlet, and a second tail gas outlet, the inlet of the second hydrogen PSA unit being in downstream fluid communication with the outlet of the compressor and the first outlet of the membrane separation unit, the burner being in downstream fluid communication with the second vent gas outlet of the second hydrogen PSA unit and the second outlet of the membrane separation unit;
a second compressor having an inlet and an outlet, the inlet of the second compressor being in downstream fluid communication with the tail gas outlet of the second hydrogen PSA unit, the inlet of the hydrogen production unit being in downstream fluid communication with the outlet of the second compressor.
